(19) United States
(12) Patent Application Publication
(10) Pub. No.: US 2026/0105728 A1
(43) Pub. Date: Apr. 16, 2026

(54) MODEL FOR ROTATED BOUNDING BOX OBJECT DETECTION, AND METHOD AND DEVICE FOR ROTATED BOUNDING BOX OBJECT DETECTION

(71) Applicant: Hollyway Group Pte. Ltd., Singapore (SG)

(72) Inventor: Larry LEE, Singapore (SG)

(21) Appl. No.: 18/912,638

(22) Filed: Oct. 11, 2024

(51) Int. Cl. G06V 10/774; G06V 10/25; G06V 10/77; G06V 10/776

(52) U.S. Cl. CPC G06V 10/774; G06V 10/25; G06V 10/7715; G06V 10/776

(57) ABSTRACT

This application relates to image detection technology, and specifically provides a method, device and model for training rotated bounding box object detection. The method may comprise: constructing a training dataset, wherein the training dataset comprises: prediction result and annotation result of rotation frames in the prediction result, and the annotation result comprises pixel coordinates and rotation angles of the rotation frames; inputting the prediction result into a rotated bounding box object detection model to be trained to obtain prediction result, wherein the prediction result comprises: a predicted pixel coordinate value and a predicted angle value; comparing the prediction result with the annotation result, using a loss function to optimize the rotated bounding box object detection model to be trained, and obtaining a trained rotated bounding box object detection model. Some embodiments of this application can improve the accuracy of rotated bounding box object detection.

### TECHNICAL FIELD

The present application relates to the field of image detection technology, and in particular to a method and device for training a rotated bounding box object detection model and a rotated bounding box object detection method.

### BACKGROUND

With the continuous promotion and application of object detection in various scenarios, rotated bounding box detection technology has emerged.

At present, the bounding boxes generated by object detection models are divided into axis-aligned boxes and rotated boxes (i.e., slanted boxes). Because there are many ways to define a rotated box, when performing rotated box detection, x and y pixel coordinates of four corners of the box rectangle are generally used for definition. This method can not only be used to represent rectangles, but also to define the shape of any quadrilateral. However, this method of only using the pixel coordinates of the four corners of the rectangle for detection cannot achieve accurate detection of the rotated box.

Therefore, how to provide a technical solution for a method of detecting rotated bounding boxes with high accuracy has become a technical problem that needs to be urgently solved.

### SUMMARY OF INVENTION

The objective of some embodiments of the present application is to provide a rotated bounding box object detection method and device for training a rotated bounding box object detection model. The technical solution provided by these embodiments can improve the accuracy of rotated bounding box detection and enhance the model's generalization capabilities.

First aspect: Some embodiments of the present application provide a method for training a rotated bounding box object detection model, which comprises: constructing a training dataset, wherein the training dataset comprises: prediction result and annotation result of rotated bounding boxes in the prediction result. The annotation result comprise pixel coordinates and rotation angles of the rotated bounding boxes; inputting the prediction result into the rotated bounding box object detection model to be trained to obtain prediction result, wherein the prediction result comprises: a predicted pixel coordinate value and a predicted angle value; comparing the prediction result with the annotation result and using a loss function to optimize the rotated bounding box object detection model to be trained, thereby obtaining a trained rotated bounding box object detection model.

Some embodiments of the present application train the rotated bounding box object detection model by constructing a training dataset that comprises rotation angles of the rotated boxes and optimizing the model using a loss function based on the comparison between the prediction result and annotation result, thereby obtaining a trained rotated bounding box object detection model. By incorporating rotation angles into the model to supervise the training, the embodiments of the present application can enable effective training of the rotated bounding box object detection model, improving its detection capabilities and accuracy.

In some embodiments, the rotated bounding box object detection model to be trained further comprises: a preprocessing module, an image feature extraction module, a text feature extraction module, a feature enhancement module, and a model output module; wherein, the model output module comprises pixel coordinate output dimensions and rotation angle output dimensions.

By adding a preprocessing module and increasing the output dimensions of the model output module, some embodiments of the present application allow the model structure to be adapted for rotated bounding box detection, improving the capability of rotated bounding box detection and generalization of the model.

In some embodiments, inputting the prediction result into the rotated bounding box object detection model to obtain prediction result comprises: when the prediction result is rotated, the preprocessing module updates the rotation angle; the image feature extraction module extracts image features from the prediction result to obtain a first feature; the text feature extraction module extracts text features from the prediction result to obtain a second feature; the feature enhancement module enhances the first feature and the second feature to obtain an enhanced feature; the model output module performs category prediction on the enhanced feature to obtain the prediction result.

In some embodiments of the present application, after inputting the prediction result into the rotated bounding box object detection model, various modules in the model process the prediction result to produce prediction result, to realize effective training of the model.

In some embodiments, comparing the prediction result and the annotation result, and using a loss function to optimize the rotated bounding box object detection model to be trained to obtain a trained rotated bounding box object detection model comprises: using the loss function to calculate a loss between the prediction result and annotation result to obtain a pixel coordinate loss value and angle loss value; using the pixel coordinate loss value and the angle loss value to adjust parameters of the rotated bounding box object detection model to be trained, to obtain the trained rotated bounding box object detection model.

In some embodiments of the present application, by optimizing the model parameters using both the pixel coordinate loss value and the angle loss value, high-precision rotated bounding box object detection is achieved.

In some embodiments, before obtaining the trained rotated bounding box object detection model, the method further comprises: using a validation dataset to validate the trained rotated bounding box object detection model, to obtain a model accuracy value; confirming that the model accuracy value is greater than or equal to a preset threshold.

In some embodiments of the present application, by performing accuracy validation of the dataset on the trained rotated bounding box object detection model, detection accuracy of the model is ensured, and the generalization of the model is improved.

Second aspect: some embodiments of the present application provide a method for rotated bounding box object detection, comprising: obtaining an annotated image of a rotated bounding box to be detected; inputting the annotated image of the rotated bounding box to be detected into the trained rotated bounding box object detection model obtained in any method provided by the first aspect, to obtain a detection result.

In some embodiments of the present application, by using the trained rotated bounding box object detection model to detect the annotated image of the rotated bounding box to be detected to obtain the rotated bounding box object detection result, the detection efficiency is high, and the detection accuracy is high.

Third aspect: some embodiments of the present application provide a device for training a rotated bounding box object detection model, comprising: a construction module, which is used for constructing a training dataset, wherein the training dataset comprises: a prediction result and an annotation result of a rotated bounding box in the prediction result, the annotation result comprising pixel coordinates and a rotation angle of the rotated bounding box; a prediction module, which is used for inputting the prediction result into a rotated bounding box object detection model to be trained, and obtaining a prediction result, wherein the prediction result comprises: a predicted pixel coordinate value and a predicted angle value; a training module, which is used for comparing the prediction result with the annotation result, using a loss function to optimize the rotated bounding box object detection model to be trained, and obtaining a trained rotated bounding box object detection model.

Fourth aspect: some embodiments of the present application provide a computer-readable storage medium containing a computer program, which, when executed by a processor, implements any method described in the first aspect.

Fifth aspect: some embodiments of the present application provide an electronic device, including a memory, a processor, and a computer program stored in the memory and executable on the processor, wherein, when the processor executes the program, the method of any embodiment described in the first aspect is implemented.

Sixth aspect: some embodiments of the present application provide a computer program product, the computer program product comprising a computer program, which, when executed by a processor, implements the method of any embodiment described in the first aspect.

### BRIEF DESCRIPTION OF DRAWINGS

In order to more clearly illustrate the technical solutions of some embodiments of the present application, the following will briefly introduce the drawings required to be used in some embodiments of the present application. It should be understood that the following drawings only show some embodiments of the present application, and therefore should not be regarded as limiting the scope. For ordinary technicians in this field, other relevant drawings can also be obtained based on these drawings without creative work.

FIG. 1 is a system diagram of training a rotated bounding box object detection model provided by some embodiments of the present application;

FIG. 2 is a flow chart of a method for training the rotated bounding box object detection model provided by some embodiments of the present application;

FIG. 3 is a structural diagram of an existing GroundingDINO model provided by some embodiments of the present application;

FIG. 4 is an image schematic diagram of a Sigmoid function provided by some embodiments of the present application;

FIG. 5 is a flow chart of a method for rotated bounding box object detection provided by some embodiments of the present application;

FIG. 6 is a block diagram of a device for training the rotated bounding box object detection model provided by some embodiments of the present application;

FIG. 7 is a schematic diagram of an electronic device provided by some embodiments of the present application.

### DETAILED DESCRIPTION OF THE INVENTION

The technical solutions in some embodiments of the present application will now be described in conjunction with the accompanying drawings from these embodiments.

It should be noted that similar reference numbers and letters in the following drawings represent similar elements. Therefore, once an element is defined in one drawing, it does not need to be further defined or explained in subsequent drawings. Additionally, in the description of the present application, the terms “first,” “second,” etc., are used solely for distinction purposes and should not be understood to indicate or imply relative importance.

In related technologies, the advent of the transformer model architecture has sparked a wave of innovation in deep learning. The SOTA model structures in the field of computer vision have also gradually evolved. Among them, the open-set object detection model GroundingDINO has achieved significant breakthroughs in open-set object detection tasks, reaching 52.5 AP in zero-shot on the COCO dataset, and after fine-tuning, achieving 63.0 AP. However, GroundingDINO is limited to axis-aligned bounding box detection, and its accuracy on remote sensing datasets like DOTA, which have arbitrary object orientations, dense distributions, large aspect ratios, and complex backgrounds, is relatively low. In industrial scenarios, the recognition of gauges and dials also requires angle information. To enhance the generalization capability of GroundingDINO in different business scenarios, rotated bounding box detection technology has emerged. This technology improves the model's ability to recognize objects in more scenarios without compromising basic detection accuracy.

In real-world business applications, the bounding box format generated by object detection models can be either axis-aligned or rotated boxes. Among them, the bounding boxes generated by YOLOv5 and GroundingDINO are axis-aligned boxes. The improved version, YOLOv5_OBB, also supports the localization and recognition of rotated objects. However, the input format of the training dataset for GroundingDINO is different from that of YOLOv5. The training data for object recognition models typically consists of image sets and corresponding annotations. Among them, the annotations include the object categories and the pixel position information corresponding to the categories in the images, which are the bounding boxes. Rectangular bounding boxes generally have two types: axis-aligned and rotated. Axis-aligned bounding boxes can be represented in two ways: by the x0 and y0 pixel coordinates of the top-left corner of the rectangle, along with the x1 and y1 coordinates of the bottom-right corner; by the cx and cy pixel coordinates of the center of the rectangle, along with the rectangle's width and height. Rotated bounding boxes, on the other hand, have more diverse definitions. If we disregard the differences in angle ranges and the distinction between radians and degrees, most rotated bounding boxes are defined by adding an angle theta to the axis-aligned box. Another method is to use the x and y pixel coordinates of the four corners of the rectangle. This method can be used to represent not only rectangles but also arbitrary quadrilateral shapes. This format is what YOLOv5 accepts as input. The original training data format of GroundingDINO is defined using the x0 and y0 pixel coordinates of the top-left corner of the rectangle and the x1 and y1 coordinates of the bottom-right corner. Therefore, YOLOv5_OBB does not require changes in its data preprocessing method, but the same strategy cannot be used to implement rotated bounding box detection for GroundingDINO.

Additionally, in terms of model structure, YOLOv5 is a closed-set object detection model composed purely of a vision transformer (ViT). GroundingDINO, as an open-set object detection model, includes a text encoder in addition to the vision transformer, which is used to extract textual information of unknown categories and combine it with the visual module for recognition. When generating angular information in the image output head module, modifications to GroundingDINO need to avoid the cross-attention layer that combines image and text information.

From the above related technologies, it is evident that the GroundingDINO model in existing technologies cannot achieve detection of rotated objects.

In view of this, some embodiments of the present application provide a method for training a rotated bounding box object detection model. This method involves using a constructed training dataset that contains annotation information for rotation angles to train an improved rotated bounding box object detection model, and optimizing it through a loss function, to obtain a trained rotated bounding box object detection model that can be used for rotated object detection. Some embodiments of the present application can achieve accurate and efficient detection of rotated objects by training the model with the constructed corresponding training dataset, thereby enhancing the generalization capability of the model.

The overall structure of a system for training a rotated bounding box object detection model provided by some embodiments of the present application is exemplified in conjunction with FIG. 1.

As shown in FIG. 1, some embodiments of the present application provide a system for training a rotated bounding box object detection model. The system for training the rotated bounding box object detection model may comprise: a terminal 100 and a server 200. Among them, the terminal 100 can send annotated relevant data to the server 200, so that the server 200 can construct a training dataset containing rotation angles. The server 200 trains an improved GroundingDINO model (as a specific example of the rotated bounding box object detection model to be trained) after processing the training dataset, then performs optimization through a loss function and outputs a trained rotated bounding box object detection model.

In some embodiments of the present application, the terminal 100 can be a mobile terminal or a non-portable computer terminal, and the embodiments of the present application are not specifically limited here. Besides the GroundingDINO model, other types of models that can be used for rotated bounding box object detection can also be selected for training, and the embodiments of the present application are not limited thereto.

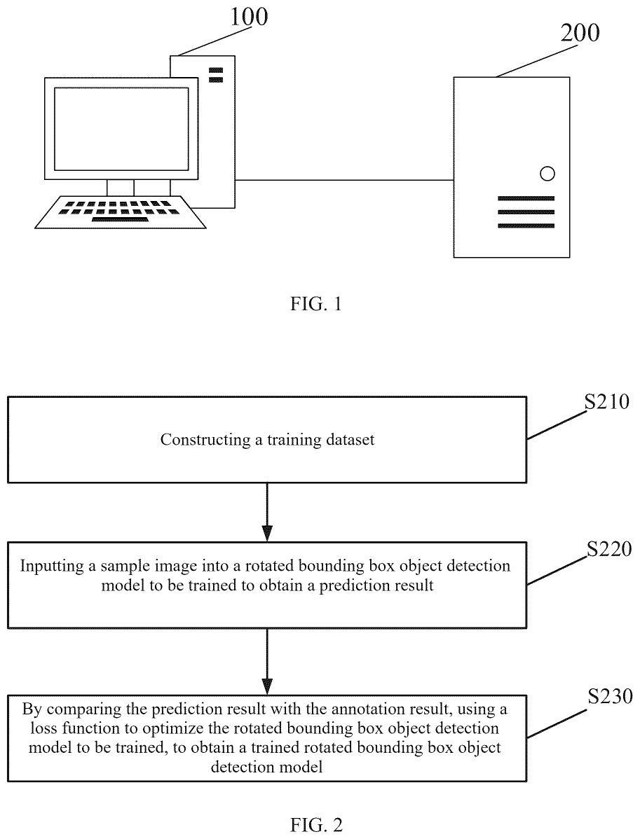

The implementation process of training the rotated bounding box object detection model performed by the server 200 provided by some embodiments of the present application is exemplified in conjunction with FIG. 2.

Please refer to FIG. 2. FIG. 2 is a flow chart of a method for training a rotated bounding box object detection model provided by some embodiments of the present application. The method for training the rotated bounding box object detection model may comprise:

S210, constructing a training dataset, wherein the training dataset comprises: prediction result and annotation result of rotated bounding boxes in the prediction result, the annotation result comprising pixel coordinates and rotation angles of the rotated bounding boxes.

For example, in some embodiments of the present application, a rotated bounding box dataset is constructed (as a specific example of a training dataset).

Using the RoLabellmg tool to annotate rotated bounding boxes in the prediction result, an angle θ∈[0, π] in radians (as a specific example of rotation angle, referred to as angle θ) is added to x0, y0, x1, y1 (as a specific example of pixel coordinates) of an original axis-aligned bounding box. A change of angle annotation of RoLabellmg is determined by the rotation of the bounding box. Specifically, rotation is started in a clockwise direction, with 0 degrees as a starting point. After rotating 180 degrees, the annotation gradually increases from 0 to π. As the rotation angle exceeds 180 degrees, the annotation resets to zero, and when the annotation angle θ increases to π again, this means that the bounding box has rotated 360 degrees and returned to the starting point. If the rotation is counterclockwise, the angle annotation θ decreases from π to 0, and after exceeding 180 degrees, decreases from π back to 0. Among them, the prediction result can be remote sensing images or other types of images, and the embodiments of the present application are not specifically limited here.

S220, inputting the prediction result into the rotated bounding box object detection model to be trained to obtain prediction result, wherein the prediction result comprises: a predicted pixel coordinate value and a predicted angle value.

For example, in some embodiments of the present application, the improved GroundngDINO model is trained by the rotated bounding box dataset constructed above to obtain the prediction result corresponding to the prediction result.

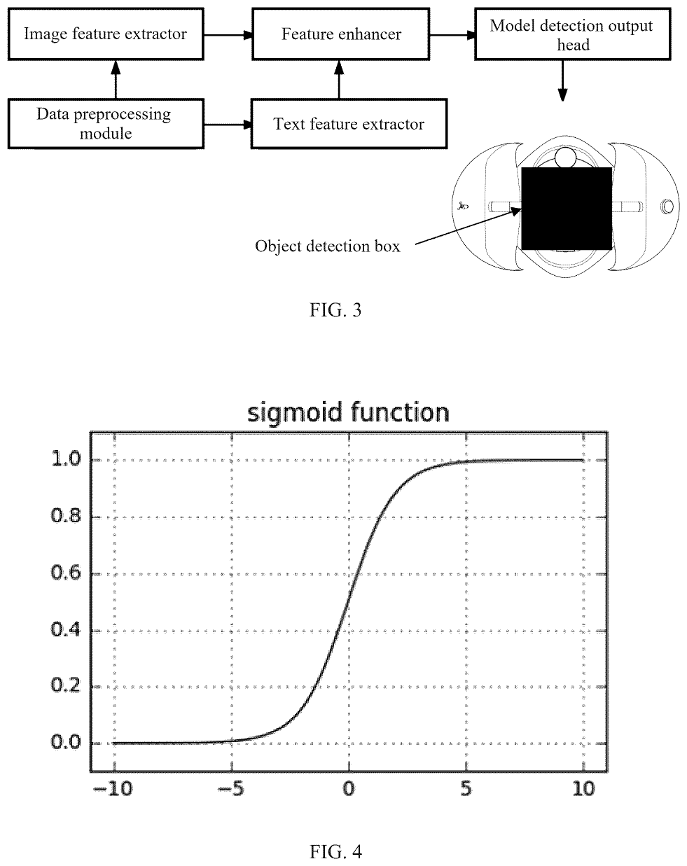

In the prior art, as shown in FIG. 3, a structure of the current GroundingDINO model generally consists of five components: a data preprocessing module, an image feature extractor, a text feature extractor, a feature enhancer, and a model detection output head (referred to as “the output head”). Because the input to the GroundingDINO model consists of a images and corresponding annotation files, the angle θ is written into the annotation file as a supervised value that the GroundingDINO model needs to learn. The existing image feature extractor does not need to be modified. The text feature extractor can detect a category of the image, which is divided into hangar feature points and lead screw feature points in the application scenario of vision-guided landing. Of course, the angle θ has no effect on the image features and text features mentioned above. Therefore, the only parts that need to be improved in the structure of the GroundingDINO model are the data preprocessing involved in processing annotations and the output head for generating angles.

Based on this, in some embodiments of the present application, S220 may comprise: the rotated bounding box object detection model to be trained further comprises: a preprocessing module, an image feature extraction module, a text feature extraction module, a feature enhancement module, and a model output module; wherein the model output module comprises: a pixel coordinate output dimension and an angle output dimension.

For example, in some embodiments of the present application, in the data preprocessing portion, it is necessary to improve the data reading function in the data preprocessing of GroundingDINO and add a preprocessing module. When rotating, counter-rotating, or other enhancement operations are performed on the prediction result, the angle θ will change. Therefore, the preprocessing module is required to detect the angle so that the correct angle information can be retained in the training dataset of the GroundingDINO model, and the value range θ∈[0, π] can be accurate in the subsequent loss calculation and be consistent with the prediction result.

The output head of the GroundingDINO model is actually a decoder part of a transformer structure. The structure of the model output is originally a bounding box that selects a specified category, represented by a center point x coordinate cx, a center point y coordinate cy, a width w of the bounding box, and a height h of the bounding box. Now, since the GroundingDINO model needs to output the corresponding angle, it is necessary to add a dimension to the original four-dimensional output to achieve angle prediction. In the decoder structure, each attention layer is followed by a fully connected structure, that is, MLP. For the improvement of the output head, the method to achieve increasing output dimensionality is to increase the output dimensions of the MLP mapping matrix. The existing mapping matrix can transform the multi-dimensional output of the attention layer into the final four-dimensional model prediction result cx, cy, w, h. By increasing the output dimensions of the mapping matrix, an additional angle θ can be output in addition to the original output result. Therefore, the model output module in the improved GroundingDINO model in the embodiment of the present application comprises: a four-dimensional pixel coordinate output dimension and an angle output dimension.

In some embodiments of the present application, S220 may comprise: when the prediction result is rotated, the preprocessing module updates the rotation angle; the image feature extraction module extracts image features from the prediction result to obtain a first feature; the text feature extraction module extracts text features from the prediction result to obtain a second feature; the feature enhancement module enhances the first feature and the second feature to obtain an enhanced feature; the model output module performs category prediction on the enhanced feature to obtain the prediction result.

For example, in some embodiments of the present application, through the improved GroundingDINO model, after inputting the training dataset, the data reading function can read the prediction result and the annotations. When rotating, counter-rotating, and other operations are performed on the prediction result, the corresponding rotation angle can be updated through the preprocessing module to ensure the consistency of the rotation angle. Afterwards, the image feature extraction module (i.e., the image feature extractor) and the text feature extraction module (i.e., text feature extractor) can respectively perform corresponding feature extraction on the prediction result, and then the feature enhancement module (i.e., the feature enhancer) performs feature enhancement processing to obtain enhanced features. Finally, the model output module can process the enhanced features and output the predicted pixel coordinate values and predicted angle values.

S230, by comparing the prediction result with the annotation result, using the loss function to optimize the rotated bounding box object detection model to be trained, to obtain a trained rotated bounding box object detection model.

For example, in some embodiments of the present application, the loss between the prediction result and the annotation result is calculated by the loss function, so as to optimize the GroundingDINO model through the loss, outputting the trained GroundingDINO model (as a specific example of a trained rotated bounding box object detection model).

In some embodiments of the present application, S230 may comprise: using the loss function to calculate the loss between the prediction result and the annotation result to obtain a pixel coordinate loss value and an angle loss value; using the pixel coordinate loss value and the angle loss value to adjust parameters of the rotated bounding box object detection model to be trained to obtain the trained rotated bounding box object detection model.

For example, in some embodiments of the present application, the output of the MLP layer is finally passed through a sigmoid function to obtain the prediction result. The prediction result is compared with the ground truth in the annotation file (as a specific example of the annotation result), and the loss is calculated and backpropagated to the parameters of the GroundingDINO model, allowing the parameters to be learned. Among them, the mathematical formula of the Sigmoid function is as follows: f(x)=1/(1+e−x).

However, the image of the Sigmoid function is shown in FIG. 4, and its output range is [0,1], which can be differentiated and has a smooth gradient. However, it can be seen from the function graph that because the derivative of Sigmoid is relatively small, during the backpropagation process for updating model parameters, the gradient update result will tend to approach 0, resulting in a slow convergence rate of the model in the correct direction, and even worse, the gradient will disappear, making the model parameters not able to be updated and learned. Because of the small amount of data, the objects that the model itself can learn are also relatively limited, and the angle value range is [0, π], so Sigmoid is not suitable as an activation function for predicting small-range changes in values. Therefore, the Sigmoid function cannot be used in angle prediction. The predicted angle value can be directly output by the MLP layer, and then combined with the cx, cy, and h of the previously Sigmoid-activated detection box to obtain the final rotated bounding box (as a specific example of the prediction result).

Afterwards, the loss function part of the improved GroundingDINO model enables the learning of angles to be supervised by the true angles in the training dataset, so that the GroundingDINO model can backpropagate the gradient according to the angle loss value, update the parameters of the GroundingDINO model, and allow the model to learn angle prediction to achieve convergence of the angle prediction result.

Specifically, the prediction of the angle is considered as a numerical regression task between [0, π], rather than treating the angle value as a classification prediction task. L1 loss is used as the angle loss function. L1 loss, also known as mean absolute error (MAE), refers to the average of the absolute difference between the model prediction value f(x) and the true value y. The smaller the L1 loss, the closer the model prediction is to the true angle, whereas the opposite means the model prediction value has a greater deviation. By backpropagating the gradient of the angle loss value, the model can adjust the parameters according to the magnitude of the loss. The mathematical formula of L1 loss is as follows:

$$L 1 Loss = \frac{1}{n} {\sum }_{i = 1}^{n} \vert {y}_{i} - f ( {x}_{i} ) \vert$$

By separately calculating the pixel coordinate loss value and the angle loss value, and applying gradient backpropagation, the GroundingDINO model adjusts the model parameters according to the magnitude of the loss value to obtain the trained GroundingDINO model. It should be understood that the loss function can be flexibly adjusted according to the actual application, and the embodiments of the present application are not limited to this.

In some embodiments of the present application, before outputting the trained rotated bounding box object detection model, S230 may further comprise: using a validation dataset to validate the trained rotated bounding box object detection model, and obtaining a model accuracy value; confirming that the model accuracy value is greater than or equal to a preset threshold.

For example, in some embodiments of the present application, the trained GroundingDINO model is used to perform accuracy validation on a vision-guided landing dataset (as a specific example of a validation dataset). When the model accuracy value is not less than a preset threshold (for example, 80%), the model is considered to have passed the validation, and the trained GroundingDINO model is output. It should be understood that if the model accuracy value is less than the preset threshold, the model continues to be trained and optimized until the accuracy meets the condition, and the training is terminated.

Through experiments, it can be known that the trained GroundingDINO model can achieve a MAP of 0.866 in the case of a training dataset with only a thousand images.

After the trained GroundingDINO model is obtained through the above training, the trained GroundingDINO model can be applied to rotated bounding box object detection. Therefore, in some embodiments of the present application, a method for detecting rotated bounding box objects is further provided, and the method for detecting rotated bounding box objects may comprise: obtaining an annotated rotated bounding box image to be detected; inputting the annotated rotated bounding box image to be detected into the trained rotated bounding box object detection model and obtaining a rotated bounding box object detection result.

For example, in some embodiments of the present application, the annotated rotated bounding box image to be detected generated by the object detection model is input into the trained GroundingDINO model, and the rotated bounding box detection result is output, which is efficient and accurate.

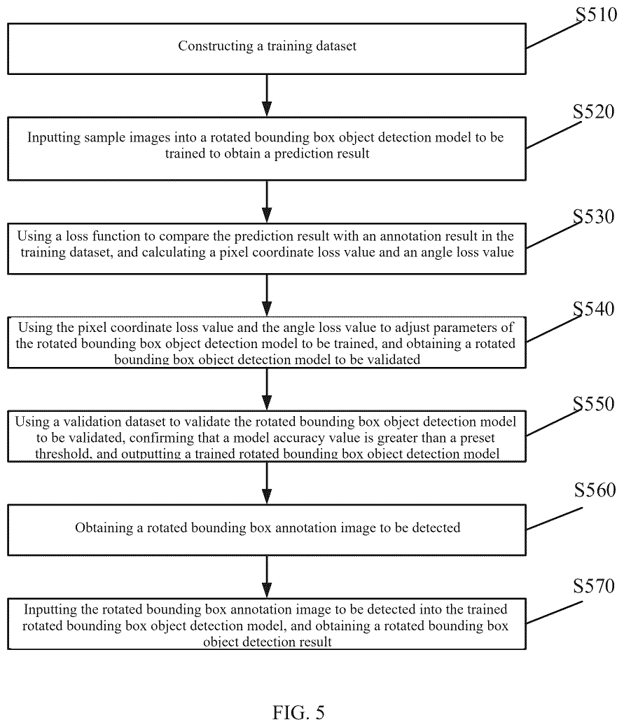

The specific process of rotated bounding box object detection provided by some embodiments of the present application is exemplified in conjunction with FIG. 5.

Please refer to FIG. 5. FIG. 5 is a flow chart of a method for detecting rotated bounding box objects provided by some embodiments of the present application.

The above process is exemplified below.

S510, constructing a training dataset.

S520, inputting prediction result into a rotated bounding box object detection model to be trained to obtain a prediction result.

S530, using a loss function to compare a prediction result with an annotation result in the training dataset, and calculating a pixel coordinate loss value and an angle loss value.

S540, using the pixel coordinate loss value and the angle loss value to adjust parameters of the rotated bounding box object detection model to be trained, and obtaining a rotated bounding box object detection model to be validated.

S550, using a validation dataset to validate the rotated bounding box object detection model to be validated, confirming that a model accuracy value is greater than a preset threshold, and outputting a trained rotated bounding box object detection model.

S560, obtaining a rotated bounding box annotation image to be detected.

S570, inputting the rotated bounding box annotation image to be detected into the trained rotated bounding box object detection model, and obtaining a rotated bounding box object detection result.

It should be noted that the specific implementation process of S510-S570 can refer to the method embodiment provided above. To avoid repetition, the detailed description is appropriately omitted here.

Through some embodiments of the present application described above, it can be known that the present application can make full use of the basic recognition ability of the visual language model GroundingDINO. After changing the rotated bounding box version, it can converge faster and with less loss than YOLOv5_OBB when the amount of training data is small, thus proving that it is a rotated bounding box object detection model with higher accuracy and stronger generalization ability. The present application improves the recognition ability of GroundingDINO for objects with arbitrary direction angles, dense distribution, large aspect ratio, and complex background, thereby improving the generalization of the model in industrial application scenarios. The dataset with more than one thousand rotated bounding box annotation images constructed by the present application can be applied to the training and fine-tuning process of other rotated bounding box models, so that the model can optimize the ability to recognize rotated bounding box objects.

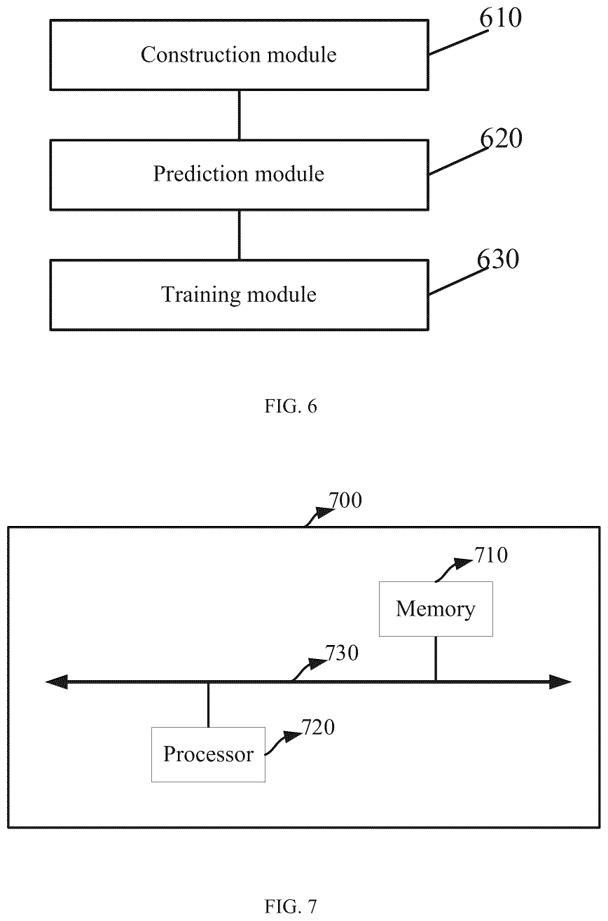

Please refer to FIG. 6, which shows a block diagram of a composition of a device for training a rotated bounding box object detection model provided by some embodiments of the present application. It should be understood that the device for training a rotated bounding box object detection model corresponds to the above method embodiment and can execute the various steps involved in the above method embodiment. The specific functions of the device for training a rotated bounding box object detection model can be found in the description above. To avoid repetition, the detailed description is appropriately omitted here.

The device for training a rotated bounding box object detection model of FIG. 6 comprises at least one software function module that can be stored in a memory in the form of software or firmware or fixed in the device for training a rotated bounding box object detection model. The device for training a rotated bounding box object detection model comprises: a construction module 610, which is used for constructing a training dataset, wherein the training dataset comprises: a prediction result and an annotation result of a rotated bounding box in the prediction result, the annotation result comprising pixel coordinates and a rotation angle of the rotated bounding box; a prediction module 620, which is used for inputting the prediction result into a rotated bounding box object detection model to be trained, and obtaining a prediction result, wherein the prediction result comprises: a predicted pixel coordinate value and a predicted angle value; a training module 630, which is used for comparing the prediction result with the annotation result, using a loss function to optimize the rotated bounding box object detection model to be trained, and obtaining a trained rotated bounding box object detection model.

In some embodiments of the present application, the rotated bounding box object detection model to be trained further comprises: a preprocessing module, an image feature extraction module, a text feature extraction module, a feature enhancement module, and a model output module; wherein the model output module comprises: a pixel coordinate output dimension and an angle output dimension.

In some embodiments of the present application, the prediction module 620 is used for the preprocessing module to update the rotation angle when the prediction result is rotated; the image feature extraction module performs image feature extraction on the prediction result to obtain a first feature; the text feature extraction module performs text feature extraction on the prediction result to obtain a second feature; the feature enhancement module performs enhancement processing on the first feature and the second feature to obtain an enhanced feature; the model output module performs category prediction on the enhanced feature to obtain the prediction result.

In some embodiments of the present application, the training module 630 is used for using a loss function performing loss calculation on the prediction result and the annotation result to obtain a pixel coordinate loss value and an angle loss value; the pixel coordinate loss value and the angle loss value are used to adjust parameters of the rotated bounding box object detection model to be trained to obtain the trained rotated bounding box object detection model.

In some embodiments of the present application, the training module 630 is used for using a validation dataset to validate the trained rotated bounding box object detection model to obtain a model accuracy value; and confirming that the model accuracy value is greater than or equal to a preset threshold.

Some embodiments of the present application further provide a device for detecting a rotated bounding box object, comprising: an obtaining module used for obtaining a rotated bounding box annotation image to be detected; a detection module used for inputting the rotated bounding box annotation image to be detected into a trained rotated bounding box object detection model to obtain a rotated bounding box object detection result.

A person skilled in the art should clearly understand that for the convenience and simplicity of description, the specific working process of the device described above can refer to the corresponding process in the aforementioned method, and will not be described in detail here.

Some embodiments of the present application further provide a computer-readable storage medium on which a computer program is stored, and when the program is executed by a processor, the operations of methods corresponding to any of the above methods provided in the above embodiments can be implemented.

Some embodiments of the present application further provide a computer program product, the computer program product comprising a computer program, wherein the computer program, when executed by a processor, can implement the operations of the methods corresponding to any of the above methods provided in the above embodiments.

As shown in FIG. 7, some embodiments of the present application provide an electronic device 700, the electronic device 700 comprising: a memory 710, a processor 720, and a computer program stored in the memory 710 and executable on the processor 720, wherein the processor 720 reads the program from the memory 710 through a bus 730 and executes the program to implement the methods of any of the above embodiments.

The processor 720 can process digital signals and can comprise various computing architectures, such as a complex instruction set computer architecture, a reduced instruction set computer architecture, or a structure that implements a combination of multiple instruction sets. In some embodiments, the processor 720 can be a microprocessor.

The memory 710 can be used to store instructions executed by the processor 720 or data related to the execution of instructions. These instructions and/or data may comprise codes for implementing some or all functions of one or more modules described in the embodiments of the present application. The processor 720 of the disclosed embodiment may be used to execute instructions in the memory 710 to implement the method shown above. The memory 710 comprises a dynamic random access memory, a static random access memory, a flash memory, an optical memory, or other memory known to those skilled in the art.

The above description is only an embodiment of the present application and is not intended to limit the scope of protection of the present application. For those skilled in the art, the present application may have various changes and variations. Any modifications, equivalent substitutions, improvements, etc. made within the spirit and principles of the present application shall be comprised in the scope of protection of the present application. It should be noted that similar numbers and letters represent similar items in the following drawings. Therefore, once an item is defined in one FIG., it does not need to be further defined and explained in the subsequent drawings.

The above description is only a specific embodiment of the present application, but the scope of protection of the present application is not limited thereto. Any changes or substitutions, which a technician familiar with the technical field can easily think of within the technical scope disclosed in the present application, should be comprised in the scope of protection of the present application. Therefore, the scope of protection of the present application shall be based on the scope of protection of the claims.

It should be noted that, in this article, relational terms such as first, second, etc. are only used to distinguish one entity or operation from another entity or operation, and do not necessarily require or imply any such actual relationship or order between these entities or operations. Moreover, the terms “comprise”, “include”, or any other variants thereof are intended to cover non-exclusive inclusion, so that a process, method, article, or device comprising a series of elements comprises not only those elements, but also other elements not explicitly listed, or also comprises elements inherent to such process, method, article, or device.

In the absence of further restrictions, the elements defined by the sentence “comprising one . . . ” do not exclude the existence of other identical elements in the process, method, article, or device comprising the elements.

What is claimed is:

1. A method for training a rotated bounding box object detection model, characterized in that it comprises:
constructing a training dataset, wherein the training dataset comprises:
prediction result and annotation result of rotated bounding boxes in the prediction result, the annotation result comprising pixel coordinates and rotation angles of the rotated bounding boxes;
inputting the prediction result into the rotated bounding box object detection model to be trained to obtain prediction result, wherein the prediction result comprises: a predicted pixel coordinate value and a predicted angle value; and
by comparing the prediction result with the annotation result, using the loss function to optimize the rotated bounding box object detection model to be trained, to obtain a trained rotated bounding box object detection model.

2. The method according to claim 1, characterized in that the rotated bounding box object detection model to be trained further comprises: a data preprocessing module, an image feature extraction module, a text feature extraction module, a feature enhancement module, and a model output module; wherein the model output module comprises: a pixel coordinate output dimension and an angle output dimension.

3. The method according to claim 1, characterized in that the inputting of the prediction result into the rotated bounding box object detection model to be trained to obtain the prediction result comprises:
when the prediction result is rotated, the preprocessing module updates the rotation angle;
the image feature extraction module extracts image features from the prediction result to obtain a first feature;
the text feature extraction module extracts text features from the prediction result to obtain a second feature;
the feature enhancement module enhances the first feature and the second feature to obtain an enhanced feature; and
the model output module performs category prediction on the enhanced feature to obtain the prediction result.

4. The method according to claim 1, characterized in that the comparing of the prediction result with the annotation result, using the loss function to optimize the rotated bounding box object detection model to be trained, to obtain the trained rotated bounding box object detection model comprises:
using the loss function to calculate a loss between the prediction result and annotation result to obtain a pixel coordinate loss value and angle loss value; and
using the pixel coordinate loss value and the angle loss value to adjust parameters of the rotated bounding box object detection model to be trained, to obtain the trained rotated bounding box object detection model.

5. The method according to claim 1, characterized in that before obtaining the trained rotated bounding box object detection model, the method further comprises:
using a validation dataset to validate the trained rotated bounding box object detection model, to obtain a model accuracy value; and
confirming that the model accuracy value is greater than or equal to a preset threshold.

6. A method for rotated bounding box object detection, characterized in that it comprises:
obtaining a rotated bounding box annotation image to be detected; and
inputting the rotated bounding box annotation image to be detected into the trained rotated bounding box object detection model obtained from the method as claimed in claim 1, and obtaining a rotated bounding box object detection result.

7. A device for training a rotated bounding box object detection model, characterized in that it comprises:
a construction module, which is used for constructing a training dataset, wherein the training dataset comprises: a prediction result and an annotation result of a rotated bounding box in the prediction result, the annotation result comprising pixel coordinates and a rotation angle of the rotated bounding box;
a prediction module, which is used for inputting the prediction result into a rotated bounding box object detection model to be trained, and obtaining a prediction result, wherein the prediction result comprises: a predicted pixel coordinate value and a predicted angle value; and
a training module, which is used for comparing the prediction result with the annotation result, using a loss function to optimize the rotated bounding box object detection model to be trained, and obtaining a trained rotated bounding box object detection model.

8. A computer-readable storage medium, characterized in that the computer-readable storage medium stores a computer program, wherein the computer program is executed by a processor to perform the method as claimed in claim 1.

9. An electronic device, characterized in that it comprises a memory, a processor, and a computer program stored on the memory and executed on the processor, wherein the computer program when executed by the processor performs the method as claimed in claim 1.

10. A computer program product, characterized in that the computer program product comprises a computer program, wherein the computer program, when executed by a processor, executes the method as claimed in claim 1.
